(19) United States
(12) Patent Application Publication
(10) Pub. No.: US 2013/0044677 A1
(43) Pub. Date: Feb. 21, 2013

(54) Telecommunications System Comprising an Airborne Communication Node, Airborne Communication Node and Tactical Radio Node

(71) Applicants: Thierry Lucidarme, Colombes (FR); Gilbert Multedo, Vaureal (FR)

(72) Inventors: Thierry Lucidarme, Colombes (FR); Gilbert Multedo, Vaureal (FR)

(73) Assignee: THALES, Neuilly-sur-Seine (FR)

(21) Appl. No.: 13/509,736

(22) PCT Filed: Nov. 4, 2010
(86) PCT No.: PCT/EP2010/066782

§ 371 Date: Jun. 18, 2012

(30) Foreign Application Priority Data
Nov. 13, 2009 (FR) 0905475

(51) Int. Cl. H04W 84/06

(52) U.S. Cl. 370/316

(57) ABSTRACT

A telecommunications system comprises a number of remote subnetworks, a subnetwork comprising at least one tactical radio node NRT serving as gateway between said subnetwork and a backbone network consisting of at least one airborne communication node. An NRT node communicates with the airborne communication node by converting the wave form of the signals to be transmitted outside the subnetwork being associated with it into a wave form used by the airborne communication node, said airborne communication node transmitting the duly received signal without modifying its wave form to at least one NRT node belonging to another subnetwork. A tactical radio communication node and an airborne communication node are also disclosed.

The invention relates to a telecommunications system comprising an airborne communication node. Also the subject of the invention are an airborne communication node and a tactical radio node. It applies notably to the fields of airborne telecommunications systems.

Military tactical radio communications are usually based on ad hoc mobile networks and radio systems.

The tactical networks of the emerging battlefield comprise a set of nodes or stand alone host terminals which, because they are mobile, are sometimes in range, sometimes out of range of one another, and can generally not rely on a predefined fixed infrastructure in their environment.

The nodes located in an ad hoc communications network can move, be destroyed, or even new nodes can join the network. In other words, the environment of the network is mobile, wireless, dynamically changing and without infrastructure.

The topology of the tactical network is called “ad hoc” as it changes dynamically in time because the connectivity between the nodes can vary in time.

Furthermore, because the nodes communicate by wireless links, they often suffer the effects of radio communications, such as, for example, noise, fading and interference.

Factors such as the variable quality of the wireless links, the propagation path losses, interference due to the multiplicity of users, the dissipated power and the changes of topology can become crucial problems, particularly in urban, mountainous and jungle environments.

The connections between nodes can also be cut or established, for example according to the distance, the variation of the strength of the signals due to the multiple paths, the weather, the presence of mountains, the presence of buildings, the loss of a node, etc.

Thus, the changes of propagation and environment conditions, and the unpredictable nature of the movements of the nodes and the sporadic failures thereof, can contribute to the dynamic nature of an ad hoc network.

These phenomena are amplified in a military environment where the preservation of security, latency, reliability, intentional interference and recovery on failure are important constraints.

Furthermore, a number of tactical areas, at times far apart, have to be able to communicate with one another. For this, the use of satellite systems is useful, but induces a significant cost. Furthermore, the different areas may be located in uneven terrains and not have access to the satellite communication means.

One aim of the invention is notably to overcome the abovementioned drawbacks.

To this end, the subject of the invention is a telecommunications system comprising a number of remote subnetworks, a subnetwork comprising at least one tactical radio node NRT serving as gateway between said subnetwork and a backbone network consisting of at least one airborne communication node. An NRT node communicates with the airborne communication node by converting the wave form of the signals to be transmitted outside of the subnetwork being associated with it into a wave form used by the airborne communication node, said airborne communication node transmitting the duly received signal without modifying its wave form to at least one NRT node belonging to another subnetwork.

According to one aspect of the invention, the backbone network comprises at least one satellite, the airborne communication node transmitting the signals received from NRT nodes to said satellite and transmitting the signals received from the satellite to the NRT nodes.

According to another aspect of the invention, the wave form used between an NRT node and an airborne communication node is the same as the one used between an airborne communication node and a satellite of the system.

Also the subject of the invention is a tactical radio node NRT associated with a subnetwork. Said node comprises means for transmitting and receiving data between a subnetwork and an airborne communication node belonging to a backbone network by converting the wave form of the signas to be transmitted outside the subnetwork being associated with it into a wave form used by the airborne communication node, the reverse conversion also being supported by said node.

Also the subject of the invention is an airborne communication node. Said node comprises means for transmitting data from an NRT node associated with a subnetwork to an NRT node associated with another subnetwork, said transmission being performed without modifying the wave form of the signals transmitted. It also comprises, for example, means for transmitting data from the NRT node belonging to a subnetwork to a satellite, said transmission being performed without modifying the wave form of the signals transmitted.

According to one implementation of the airborne communication node, the latter comprises a network controller NC responsible for allocating radio resources to the NRT nodes.

The notable advantage of the invention is that it limits the payload of the airborne communication node and therefore reduces the cost of implementation. Advantageously, the invention allows for a particularly flexible deployment of an interconnection between different tactical areas.

Other features and advantages of the invention will become apparent from the following description, given as a nonlimiting illustration, made in light of the appended drawings in which:

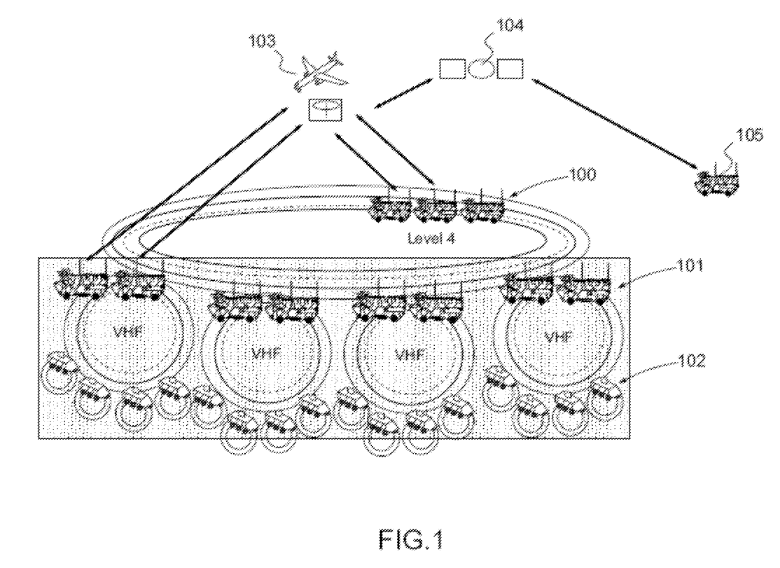

FIG. 1 gives an example of a telecommunications system linking different tactical areas;

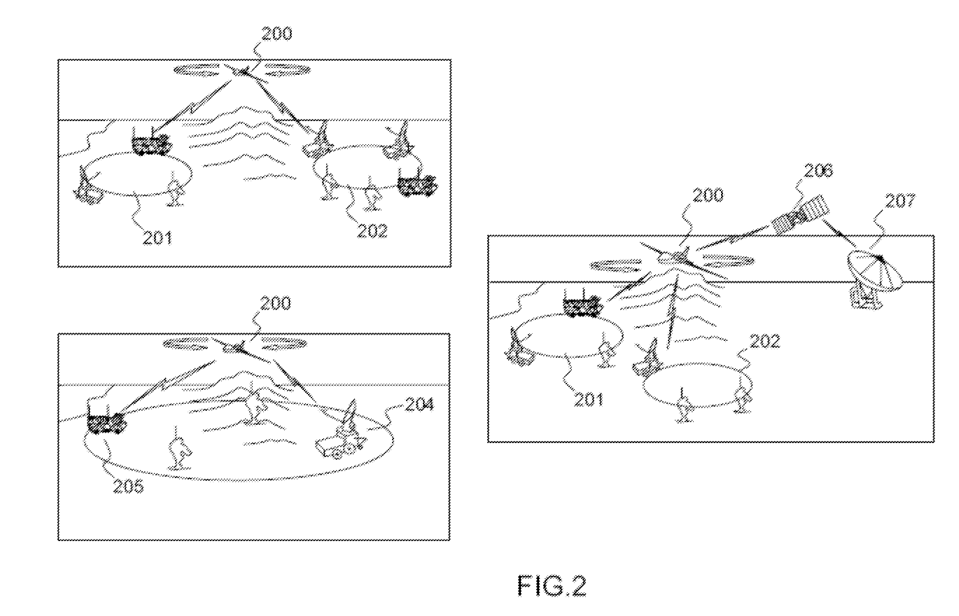

FIG. 2 illustrates the principle of a communication system relying on at least one airborne communication node;

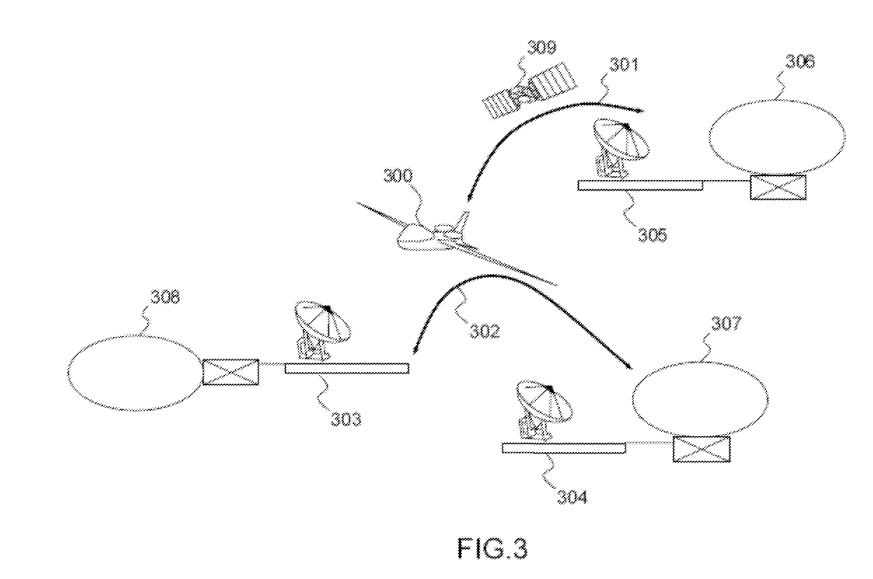

FIG. 3 gives an example of a telecommunications system architecture using an airborne communication node;

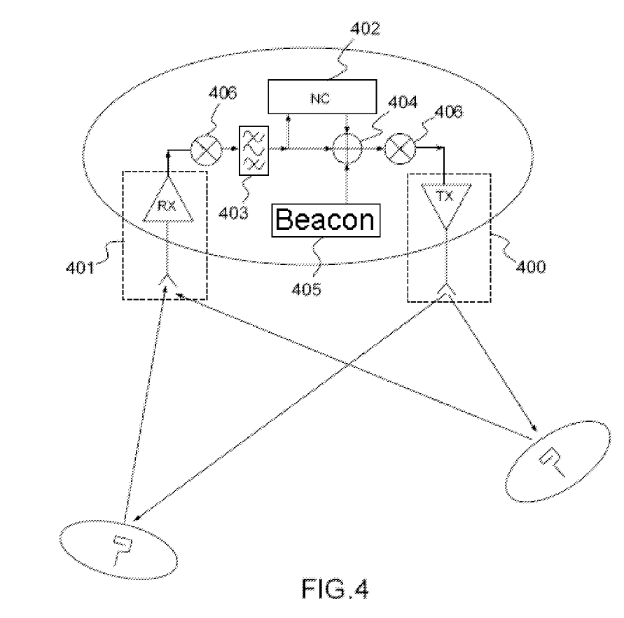

FIG. 4 gives an example of a payload corresponding to an airborne communication node;

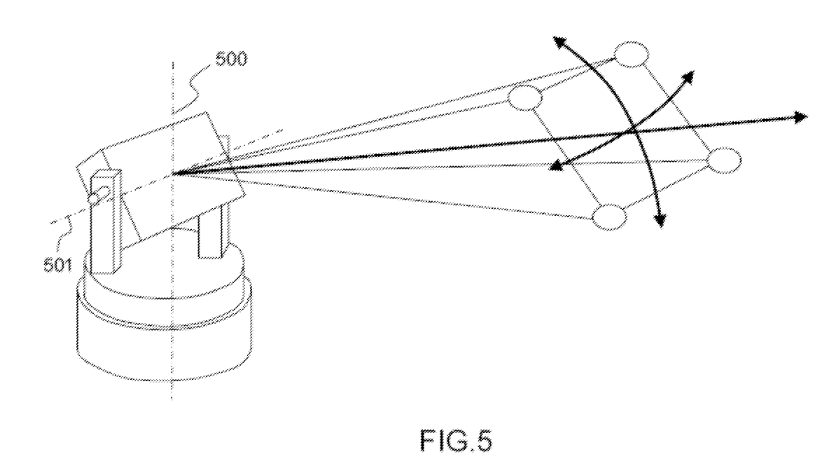

FIG. 5 gives an example of an antenna that can be used by a ground station comprising a tactical radio node NRT;

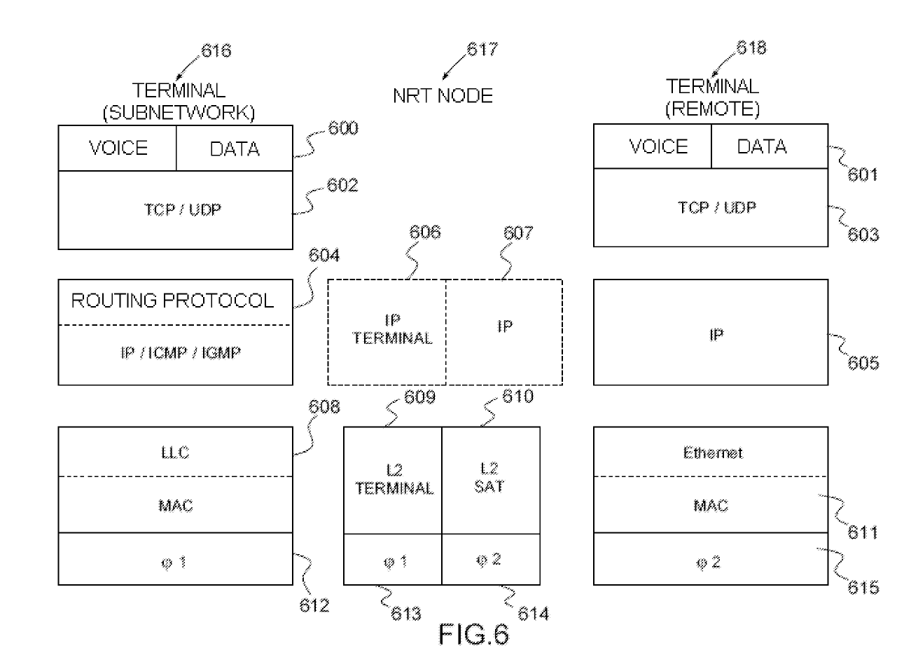

FIG. 6 gives an example of a protocol architecture that can be used for implementing the system according to the invention.

FIG. 1 gives an example of a telecommunications system linking different tactical areas. The different elements that make up the system of said system can be ranked according to the level to which they belong.

Hereinafter in the description, the example of a telecommunications system used to link different terrestial tactical areas is used, other types of communications can be considered, notably communications aiming to link a number of fleets of civil vehicles, airborne fleets or fleets of boats.

The following terminology is used:
the “level 4” 100 corresponds to the integrated battalion level;
the “level 5” 101 the sub-battalion level. It corresponds to the French appellation “SGTIA”;
the “level 6” 102 corresponds to the patrol or section level.

These levels are those used in the example proposed hereinbelow of a tactical communication system in an integrated battalion.

An integrated battalion 100 of level 4 is, for example, based on 4 level 5 sub-batallions 101, each consisting of a number of sections 102, for example 4 sections deployed over an area of 50 km square.

This type of deployment groups together, for example, a total number of transmitters of around 200.

FIG. 1 shows an assumed assignment of VHF (very high frequency) and UHF (ultra-high frequency) links within the battalion. In particular, the UHF networks are assumed to ensure overall interoperability of the data between the 200 transmitters of the battalion infrastructure.

Similarly, the VHF and UHF wave forms assure the different communication modes within the different clusters of stations of the section (combat, reconnaissance, voice, data, knowledge of the situation).

FIG. 2 illustrates the principle of an RTTA communication system relying on at least one airborne communication node.

Today, to enhance the range, notably of the terrestrial tactical communications, two solutions are usually considered.

A first solution is based on high frequency HF transmissions. The limitations of HF transmissions are essentially linked to the bit rate, usually between 800 and 4800 bits/s and to the propagation of the waves, possible only above 80 km for ionospheric propagation. A second solution is based on the use of tactical SATCOM systems.

The system described hereinbelow is based on one or more airborne communication nodes and is designated by the acronym RTTA hereinafter, said acronym standing for Réseau Tactique Terrestre Aéroporté [airborne terrestrial tactical network].

The airborne communication node makes it possible to link different tactical areas together or/and link different tactical areas to a satellite, which in turn allows for the implementation of communications with other tactical areas. The wave form used for the communications between the tactical areas and the airborne node and between the airborne node and the satellite may be different, or advantageously the same.

One exemplary implementation of the airborne communication node 200 is to install a transponder in a tactical drone, usually designated by the acronym UAV, standing for “unmanned aerial vehicle”. A network controller can be incorporated in a terrestrial terminal or on board the UAV. The airborne communication node does not include any code conversion means for converting wave forms used by one tactical area to another wave form used in another tactical area. The RTTA system is based, on the one hand, on the use of airborne communication nodes, but also on nodes called tactical radio communication nodes NRT, said nodes being able to be included in a ground station. It is the tactical radio communication nodes NRT which include the code conversion means. Thus, a single type of wave form can be used between the ground and airborne communication node. The complexity of the airborne node is then advantageously reduced.

Advantageously, the incorporation in the UAV constitutes a better configuration in terms of system vulnerability.

The RTTA and SATCOM solution can be entirely integrated when the C, X, Ku, Ka frequency band is the same.

The RTTA system provides the V/UHF tactical communication system with an enhanced connectivity of 30 nodes corresponding to level 4, level 5 and section command stations in an integrated battalion.

The RTTA system improves the communications in difficult terrain such as in urban, mountainous or jungle environment.

The combination with a SATCOM system 206, 207 advantageously provides the tactical system with BLOS capability, BLOS standing for “beyond line-of-sight”.

A simple omnidirectional antenna can be used in the airborne communication node which makes its implementation simple.

The RTTA system then makes it possible to implement iso-level and transversal communications. One objective is notably to interconnect different tactical areas 201, 202.

The RTTA system also makes it possible to ensure continuity of communication between terminals 204, 205 within a same tactical area, which can be advantageous when the operational deployment is done in a mountainous country or in an urban area, for example.

The transversal communications, that is to say, communications between different levels, can be considered as a nominal case, for example a level 5 sub-battalion reports to a remote level 4 battalion. In the same tactical area, a level 6 section communicates with a level 5 command station via the RTTA system, because no UHF or VHF connectivity can be set up because of the obstacles to propagation.

The iso-level communications, for example between two levels 5 can also take place when no VHF coverage is possible. In the same tactical area, two levels 6 can provide communications based on RTTA, again because of the obstacles to propagation.

Furthermore, extensions to the system can easily be included in the form of return links in order to anchor the theatre of traffic. Furthermore, a number of communication nodes can be interconnected using SATCOM links; thus, an airborne communication node 200 can be connected to a terrestrial communication node 207 using a satellite 206 belonging to the SATCOM system. In this case, the airborne communication node can be considered as a tactical radio concentrator which allows access to the SATCOMs.

Remote extensions for transversal and iso-level connectivity can be set up by the RTTA via the proposed SATCOM extension.

Usually, the SATCOM connectivity is used in two main cases: when the area comprising different tactical areas is too extensive or when radio connectivity is impossible, for example because of various obstacles such as mountains or buildings. The RTTA telecommunications system can therefore be considered as a possible alternative to the SATCOM systems. It can also use the potential of the SATCOM systems by interconnecting therewith.

In an exemplary organization, the RTTA system makes it possible to connect 3 command stations CP to the level 4, 2 CP for each level 5 and 1 CP for each section so that an overall connectivity of 27 nodes in a battalion deploying 200 transmitters are connected to the airborne communication node and provide the link with the tactical node via terrestrial communication nodes. The scheme below presents possible scenarios offered by the RTTA concept.

FIG. 3 gives an exemplary telecommunications system architecture using an airborne communication node.

The RTTA system can be seen as a backbone network between nodes, called NRT nodes, acting as concentration points or gateways for other nodes of the network.

These NRT nodes provide an intelligent routing function to subnetworks and make it possible to route the IP user and control plane data traffic entering and leaving the backbone network at high bit rate using the airborne communication node.

A subnetwork can be used for each tactical area, for example. A subnetwork is, for example, an ad hoc network.

As an example, the diameter of the level 5 tactical area can be 50 km.

The UAV 200 links two tactical theaters for example by their ends.

FIG. 3 gives an exemplary telecommunications system architecture comprising a backbone network making it possible to interconnect a number of subnetworks.

The RTTA system comprises a backbone network consisting of 2 main segments, namely the SATCOM segment 301 based on a satellite 309, and the tactical radio segment 302, these two segments being implemented using an airborne communication node 300.

The airborne communication nodes 300 make it possible to set up ground and SATCOM connectivity, for example. It is also possible to use airborne communication nodes making it possible to obtain ground connectivity only.

These segments 301, 302 can be seen as transit networks for information relayed between the tactical theaters via an intelligent routing function. This function makes it possible to map the user and control plane of the wave form of the subnetworks into a user plane and a control plane of the wave form of the satellite network.

The bit rate supported by the backbone of the RTTA can be, for example, of the order of 40 Mbits/s.

Each segment comprises different functions or subsystems. Thus, a segment comprises, for example, transmission subsystems, radio subsystems, resource management subsystems.

The architecture of the RTTA system is functionally based on at least one airborne communication node, installed, for example, on board a UAV, said node having to emulate a satellite transponder, but also on a plurality of tactical nodes.

The airborne communication node 300, also called SATCOM node, makes it possible to set up ground connectivity and SATCOM connectivity.

A second type is called tactical radio node NRT 303, 304, 305 which makes it possible to establish connectivity between a subnetwork 306, 307, 308 and an airborne communication node.

The architecture of the RTTA system is based, for example, on an all-IP architecture designed for a robust system with appropriate system redundancies.

For the two segments taken into account by this RTTA system architecture, the use of an all-IP adaptive transmission system is of real operational interest: firstly because of a better bit rate, and secondly because of its capacity to provide a better guarantee of connectivity.

The main reason for these two advantages is linked to the use of a packet wave form which allows for a smaller granularity compared to a circuit wave form. In effect, in the past, a circuit architecture had to have a guaranteed constant bit rate in transmission, but, in reality, the capacity of the radio channel constantly changes according to the transmission conditions (fading, interference, etc.). With the use of a dynamic adaptive IP wave form, the guaranteed bit rate can be adapted dynamically and in real time, not only to the capacity of the radio channel, but also to the operational use.

In other words, the optimization of the system is due to the possibility, with an all-IP system, of trading the system margin for additional bit rate, and vice versa. A circuit architecture with constant bit rate has, in most cases, too much system margin at the cost of capacity, and in some cases not enough system margin and loses connectivity. The use of a packet DAMA, the acronym standing for “data management association”, with ACM modulation, ACM standing for “adaptive coding and modulation”, makes it possible to dynamically allocate appropriate resources to the different users. The packet DAMA makes it possible to manage the resources, the ACM modulation makes it possible to dynamically select the optimum coding and modulation for the transmission conditions, the IP level supports these bit rate variations.

Moreover, the architecture of the RTTA system advantageously supports communications on the move for both SATCOM and tactical radio ground segment types.

The frequency hopping technology can be used and thus allows for an advanced level of availability of the radio resources. Thus, the RTTA system is capable of providing transmission services even if the radio frequency band is subject to interference.

The system can be reconfigured transparently and automatically. This allows for easy operation of the system and guarantees the benefit of an entirely optimized system.

Depending on the type of airborne communication node 300 used, the operational benefits are manifold.

When a SATCOM node is used and the latter uses a single wave form for the ground communications and the satellite communications, it is possible to use, on the different strategic areas, the same terminal, said terminal being able to operate directly with SATCOM connectivity or even with RTTA connectivity, that is to say by involving the airborne communication node of SATCOM type. In certain cases, this advantage becomes crucial, notably if strategic areas are reconfigured and this reconfiguration leads to the loss of one of the connectivities.

Furthermore, even if there is SATCOM connectivity, the RTTA capacity can be used as coverage extension. The SATCOM capacity is often saturated, the use of the RTTA connectivity makes it possible to replace a SATCOM connectivity in theater with an RTTA connectivity. Because of this, a portion of the SATCOM capacity can be saved.

The SATCOM node is, for example, equipped with a high-gain antenna, which requires accurate pointing. When it is used in the context of an RTTA connectivity, the link budget will make it possible to obtain a high bit rate, with a good system margin. The availability of the RTTA will be high, even in case of heavy precipitation.

From a purely economical point of view, the RTTA connectivity is less costly than the SATCOM connectivity. Furthermore, the use of smaller points allows for the reuse of the frequencies.

Furthermore, the RTTA connectivity makes it possible to provide a better quality of service, that is to say, shorter delays due to the proximity of the airborne communication node in relation to the tactical areas.

When a tactical radio node NRT is used, to obtain this cost saving, the tactical radio node is equipped with a low-gain antenna, which has low directivity. This greatly simplifies the pointing system in terms of size and weight.

In the system, if a Ku or Ka satellite resource is available, it is possible to envisage having the same physical antenna used to point to the satellite 301 and to the UAV 300, it the latter is visible, because a moving antenna of small size can provide a high gain in these bands.

If only the C band is available, the obligatory size of an antenna suited to SATCOM use may not be compatible with a moving system, even though a medium bit rate can be obtained in SATCOM in clear weather. In this case, two different antennas can be used on the tactical radio node NRT, a first antenna for direct SATCOM connection and a second for tracking the airborne communication node.

FIG. 4 gives an example of payload corresponding to an airborne communication node.

The airborne communication node forms part, for example, of the payload of a UAV and emulates a satellite.

In more detail, the payload may consist of the following elements:
an antenna subsystem making it possible to transmit 400 and receive 401 the tactical radio segment information;
a UAV transponder emulator: it transposes the data received from the ground segment, re-amplifies them and then transmits them to the ground segment.
A controller NC 402, NC standing for “network control”. Said controller NC is very similar to that used in a conventional SATCOM deployment and comprises the same type of functions known to those skilled in the art. Because of this, this NC handles the synchronization master function, which means that it is used as frequency and time standard. Said controller also performs the DAMA function to assign the various resources to the users of the ground segment.
An NC multiplexer 404: this makes it possible to inject the data into the controller NC and receive them therefrom. This multiplexer also handles the HPA/LNA emulation for the onboard NC;
means for implementing a control line making it possible to control the airborne communication node. Said line makes it possible to control the actual UAV but also the onboard NC function.

The benefit of implanting the controller NC in the UAV is the guarantee that it provides for the NRT node to have visibility with said controller, without which the NRT node cannot set up any link.

The radiofrequency part copies the reception signal, filters 403 the useful part thereof, by eliminating the band noise, and retransmits this signal with amplification 400. It adds, for example, DAMA signaling by using an analog coupler 404. The output of the modem of the network controller (NC) is coupled 404 to the output of the transceiver in order to deliver to the ground modems the signaling dedicated to the operation of the modems, in particular synchronization.

Furthermore, a beacon generator 405 enables the UAV to generate an analog signal which allows for acquisition and tracking by the ground antenna system.

It is also possible, if no tracking receiver is available at the ground station, to use an onboard GPS receiver to supply the location of the UAV. The position is transmitted by downlink by the integrated network controller.

It follows from the above that the transponder part of the hardware installed in the airborne communication node is strictly analog. It can use a single antenna to minimize the impact of the installation of antennas on the aircraft, or, depending on the supporting platform, if the decoupling between antennas is good, two separate antennas.

The antenna system for the onboard system will consist, for example, of one or two helical antennas providing hemispherical coverage in circular polarization, within a small volume to be integrated. The onboard circular polarization offers the advantage that, in cases of rectilinear polarization on the ground, the received signal does not depend on the orientation of the ground antennas.

FIG. 5 gives an example of an antenna that can be used by a ground station comprising a tactical radio node NRT.

The ground stations consist, for example, of mobile vehicles bearing an RTTA antenna.

The antenna is mounted, for example, on a positioning system with 2 axes 500, 501 making it possible to follow the trajectory of the airborne communication node. The antenna is an active antenna operating, for example, in band C.

Furthermore the tactical radio node may integrate, for example, transposition means from band C to band L, transposition means from band L to band C, a low-power band C amplifier, a tracking receiver, a modem and application software.

The tracking system may be based in the initial acquisition phase on the knowledge of the location of the onboard system. In the tracking phase, the system may be based on a tracking algorithm based on pitches transmitted by the onboard system.

It is also possible to use an onboard GPS receiver to supply the location of the UAV. The position may be transmitted by downlink by the onboard network controller NC. The tracking is then an open loop mode tracking.

FIG. 6 gives an example of protocol architecture that can be used to implement the system according to the invention. Three protocol stacks are represented.

A first stack 616 corresponds to the protocol layers implemented in a terminal of a subnetwork covering a given tactical area, the subnetwork being, for example, a network of ad hoc type.

A second stack 617 corresponds to the protocol layers implemented in the tactical radio nodes NRT.

A third stack 618 corresponds to the protocol layers implemented in a remote terminal, for example. A remote terminal corresponds, for example, to a control station that has established a communication link with a communication satellite of the RTTA backbone network.

The terminal of the ad hoc network and the remote terminal both have an application layer 600, 601, said layers comprising, for example, voice codecs and making it possible to process user data. These layers are based on a TCP/UDP layer 602, 603.

The user terminal comprises a level 3 layer 604, said layer itself comprising two sublayers, one corresponding to a routing protocol and the other to the IP, ICMP and IGMP protocols, said protocols being well known to those skilled in the art. The corresponding level 3 layers may optionally be implemented 606 in the NRT node if said node is responsible for a level 3 routing. An IP level 3 layer 605 is also present on the remote terminal side.

The level 2 layer 608 consists, for example, of two LLC and MAC sublayers and is implemented in the terminal of the ad hoc network. The LLC sublayer is, for example, that of the 802.11 standard. This level 2 layer is also implemented at the NRT node 609, but may be different from that used 610, 611 on the interface between said NRT node and the remote terminal, possibly consisting, for example, of an Ethernet sublayer and an MAC sublayer.

The wave form used between the terminal of the ad hoc network and the NRT node is not necessarily the same as the wave form used on the interface between the NRT node and the remote terminal. Thus, a physical layer ψ1 612, 613 is implemented for the first interface and a physical layer ψ2 614, 615 is implemented for the second interface.

1. A telecommunications system comprising a number of remote subnetworks, a subnetwork comprising at least one tactical radio node NRT serving as gateway between said subnetwork and a backbone network comprising at least one airborne communication node, wherein an NRT node communicates with the airborne communication node by converting the wave form of the signals to be transmitted outside the subnetwork being associated with it into a wave form used by the airborne communication node, said airborne communication node transmitting the duly received signal without modifying its wave form to at least one NRT node belonging to another subnetwork.

2. The system as claimed in claim 1, wherein the backbone network comprises at least one satellite, the airborne communication node transmitting the signals received from NRT nodes to said satellite and transmitting the signals received from the satellite to the NRT nodes.

3. The system as claimed in claim 2, wherein the wave form used between an NRT node and an airborne communication node is the same as the one used between an airborne communication node and a satellite of the system.

4. A tactical radio node NRT associated with a subnetwork further comprising means for transmitting and receiving data between a subnetwork and an airborne communication node belonging to a backbone network by converting the wave form of the signals to be transmitted outside the subnetwork being associated with it into a wave form used by the airborne communication node, the reverse conversion also being supported by said node.

5. An airborne communication node, further comprising means for transmitting data from an NRT node associated with a subnetwork to an NRT node associated with another subnetwork, said transmission being performed without modifying the wave form of the signals transmitted.

6. An airborne communication node further comprising means for transmitting data from the NRT node belonging to a subnetwork to a satellite, said transmission being performed without modifying the wave form of the signals transmitted.

7. The airborne communication node as claimed in claim 5, further comprising a network controller NC responsible for allocating radio resources to the NRT nodes.
